(19) United States
(12) Patent Application Publication
(10) Pub. No.: US 2016/0272263 A1
(43) Pub. Date: Sep. 22, 2016

(54) BICYCLE COMPUTER

(71) Applicant: Canyon Bicycles GmbH, Koblenz (DE)

(72) Inventor: Benedikt ZEINDL, Schoellnach (DE)

(21) Appl. No.: 15/070,708

(22) Filed: Mar. 15, 2016

(30) Foreign Application Priority Data
Mar. 17, 2015 (DE) 202015002018.6

(51) Int. Cl. B62J 99/00; G06F 1/16

(52) U.S. Cl. CPC B62J 99/00; G06F 1/1637; G06F 1/1656; B62J 2099/0013

(57) ABSTRACT

A bicycle computer comprises a housing in which a data processor and a transceiver are arranged. The computer has a display. In a preferred embodiment the latter is of a two-part design so that a closed portion and an open portion is provided. The closed portion serves to indicate permanently preset information, such as speed, number of rotations of the crank, pulse, altitude, the data calculated therefrom, etc. The open portion serves to indicate information transmitted from an external data processing means such as a mobile phone. This may be navigation data, weather data, position data or representations of apps. Further, it is preferred that the bicycle computer is integrated in a stem cap by forming the housing of the bicycle computer and the stem cap as a single piece.

### BACKGROUND

1. Field of the Disclosure

The disclosure relates to a bicycle computer.

2. Discussion of the Background Art

Known bicycle computers serve to indicate use-specific data such as speed, number of rotations of the crank, the current altitude, as well as data calculated therefrom, such as average speed, maximum speed, maximum altitude, minimum altitude, rate of climb etc. These data are determined by means of sensors. For example, such a sensor may be a sensor attached to a fork leg of the front wheel fork or to a chain stay, the sensor cooperating with a magnet attached to a spoke. A corresponding sensor or a sensor combined with the above-mentioned sensor may be provided at a chain stay for detecting the number of rotations of the crank. Another sensor for measuring altitude may for example be designed as a barometric altimeter and may in particular be arranged within the housing of the bicycle computer. It is further possible to display user-specific data, such as the pulse, on the display of the bicycle computer. To this end it is known to arrange a corresponding sensor on the body of the user, e.g. by means of a breast strap. A data processing means is arranged inside the housing of the bicycle computer. A receiver means that is also arranged in the housing is connected with the data processing means. The receiver means serves to receive data, in particular in a wireless manner, from sensors arranged on the bicycle and/or on the user. Further, the data processing means may be connected with a sensor arranged in the housing, such as an altitude sensor. The corresponding information to be displayed may be selected by the user by means of software. Further, the housing is connected with a fixture device for fastening the bicycle computer on the bicycle handlebar which is also provided with a fixture device.

It is an object of the disclosure to provide a bicycle computer that may be arranged on a bicycle in a simple manner, in particular in the region of the bicycle handlebar or the stem. Another object, independent of the former, is to improve the functionality of the bicycle computer.

### SUMMARY

In a first preferred embodiment the fixture device of the bicycle computer is designed such that it is configured for being fastened on a stem cap. The stem cap serves to fix the handlebar on the stem. Usually, the stem cap has a substantially semi-annular cross section with four protrusions that serve to fasten the stem cap to a complementarily shaped fixture device of the stem by means of four fastening screws and to thereby fix the handlebar. Owing to the fixture device being designed according to the present disclosure such that it is designed for fastening on a stem cap, it is possible to omit a separate fixture device that is to be arranged for instance on the handlebar or the stem and cooperates with the fixture device of the bicycle computer.

In a preferred development of this embodiment the fixture device has at least one, in particular two protrusions. The at least one protrusion, in particular both protrusions each have an opening to pass a fastening screw for the stem cap therethrough. With this preferred embodiment the bicycle computer is fastened by means of one or two fastening screws that at the same time serve to fix the stem cap and thus the handlebar. According to the disclosure, the in particular two upper fastening screws of the stem cap thus have a dual function by retaining the stem cap and thereby fixing the handlebar on the one hand and by retaining the bicycle computer on the other hand.

This embodiment is particularly suited for retrofitting, where it may at most be necessary to provide longer fastening screws.

Seen from an upper side of the bicycle computer display the one, in particular the two protrusions preferably extend upward. This allows for a simple mounting of the bicycle computer.

In the mounted state the bicycle computer is preferably arranged such that the display is oriented horizontally or slightly slanted upward in the traveling direction.

In another independent embodiment the housing of the bicycle computer is formed integrally with the stem cap. In the preferred embodiment the stem cap thus is a part of the housing. No separate fixture device must be provided on the housing of the bicycle computer. This has the advantage that when the handlebar is mounted, the bicycle computer is directly mounted as well. In particular, this is also advantageous in that the way of mounting the bicycle computer reduces the risk of theft.

Preferably, the connection between the housing and the stem cap is made in an upper portion of the stem cap, seen in the mounted state of the stem cap. Thus, the connection is preferably made near the in particular two upper fastening screws of the stem cap.

Also in this embodiment it is preferred that, in the mounted state, the display is oriented substantially horizontally or slightly slanted upward in the traveling direction so that the display of the bicycle computer is well visible for the cyclist.

Another disclosure consists in improving the functionality of the bicycle computer. This disclosure is independent from the fastening of the bicycle computer, while it is preferred that the bicycle computer is embodied according to one of the above described disclosures. Such a bicycle computer also has a housing in which a data processing means and a receiver means for receiving data from sensors arranged on the bicycle or on a user. Further, the housing is connected with a display for the display of information. According to the disclosure, the display has two portions. A closed portion serves to display permanently preset information. These are data that are also displayed on conventional known bicycle computers such as speed, number of rotations of the crank, pulse, altitude, as well as information calculated therefrom such as average speed, maximum speed, climb rate, maximum altitude, etc. The second, open portion serves to display information transmitted from an external data processing means such as a mobile phone. This may, for example, be information for the purpose of navigation, weather information, and also information calculated by the external data processing means by means of apps. For example, during a bicycle race, such information may relate to one's position in the field of cyclists and to the position of defined other cyclists in the field such as teammates. Preferably, the external data processing means is a mobile phone. Providing such an open portion has the advantage that the information to be shown therein can be selected very freely. In particular, it is possible to use the substantially higher computing power of the external data processing means. Further, it is possible to use the capabilities of this external data processing means, such as a mobile Internet link, a GPS module integrated in the external data processing means and the like.

The bicycle computer may comprise an additional receiver means for data transmission to the bicycle computer. As an alternative, it is also possible to configure the existing receiver means in a corresponding manner, so that it is also suited for receiving data from the external data processing means. In this regard, it is preferred that this receiver means or the additional receiver means receives the data via Bluetooth.

Further, it is preferred that the size of the two portions is variable. Here, the size of the two portions may be set by a user either in a variable manner or in recommended size steps. Moreover, it is also possible to change the size of the portions dynamically. This is useful, for example, when important navigation data are displayed. In this regard, it is possible that the entire display exclusively shows the open portion so that a large indication of important navigation data is possible.

It is further preferred that the bicycle computer also has a transmitter means. Using this transmitter means, it is possible to transmit in particular the data detected by the sensors on the bicycle, the user or in the bicycle computer itself and to also transmit calculated data to the external data processing means. Moreover, it is also possible to combine or correlate the data in the processing means of the bicycle computer or the external data processing means and to gain new information therefrom.

In this manner it is possible, in another preferred embodiment, to transmit data acquired in different ways from the external data processing means also via the mobile radio network. For this purpose it is particularly preferred that the bicycle computer knows bicycle identification data such as an identification number. The same may be stored directly in the board computer or it may be transmitted by one of the sensors arranged on the bicycle or integrated in the bicycle. This is advantageous in that the data determined can be unambiguously allocated to a specific bicycle.

Such data transmission may be directed, for example, to the bicycle manufacturer. Using a corresponding data analysis, the bicycle manufacturer may for example statistically evaluate the preferred use of respective kinds of bicycles. This may then be taken into account in product development.

Further, it is preferred that maintenance intervals are determined using the data processing means integrated in the bicycle computer and/or the external data processing means.

These may, for example, merely depend on a certain mileage. In addition, corresponding algorithms may also consider the height meters overcome and possibly even the slope. Using a corresponding algorithm, it would for example be possible to take into account that, depending on the height meters overcome and the slope, the chain and the brake pads are possibly stressed more so that a service or maintenance is recommended already at a lesser mileage.

In particular when transmitting maintenance recommendations, it is possible to additionally transmit data that for example relate to the bicycle-specific brake pads, the existing chain etc. This is possible if corresponding data have been entered once by the user or already by the manufacturer. Moreover, it is possible to route the cyclist directly to an Internet site where the spare parts required for maintenance can be ordered. In addition, it is possible to offer instructions on mounting or maintenance to the cyclist via the Internet.

In particular it is possible to provide the bicycle with a sensor for detecting a fall. This may for example be a sensor that detects the shock. In particular, if a cyclist travels alone, this is a considerable gain in safety. When a fall is detected, an emergency call may be emitted immediately. This may be done via the data processing means or directly via a mobile phone carried along or the transceiver means itself. In this context it is preferred that GPS data are also transmitted directly to the corresponding emergency call centre. Moreover, the emergency call centre may automatically activate a return call in order to contact the cyclist and to initiate the rescue measures that are possible necessary.

Based on the data transmitted and possibly on data additionally stored in the data processing system, it is possible to transmit data relating to maintenance to be carried out and the like to a data output means such as a PC or the mobile phone. Preferably, the usual tacho data, statistics, trekking data etc. are transmitted. Further, it is possible to provide data for a direct ordering of spare parts, mounting and maintenance instructions and the like, via the in particular mobile data output device.

It is particularly preferred that the data acquisition and/or the data processing and/or the data transmission are started automatically as soon as the bicycle is moved. With the sensors provided it can be determined in a simple manner that the bicycle is moved. This may be effected by means of the GPS module, a REED sensor, the speed sensor and the like.

The disclosure will be explained in more detail hereunder with reference to preferred embodiments and to the accompanying drawings.

### BRIEF DESCRIPTION OF THE DRAWINGS

In the Figures:

FIG. 1 is a schematic side elevational view of a first preferred embodiment of a separate bicycle computer,

FIG. 2 is a schematic top plan view on the bicycle computer shown in FIG. 1 and

FIG. 3 is a schematic perspective view of a second embodiment of an integrated bicycle computer according to the disclosure.

### DETAILED DESCRIPTION OF THE PREFERRED EMBODIMENT

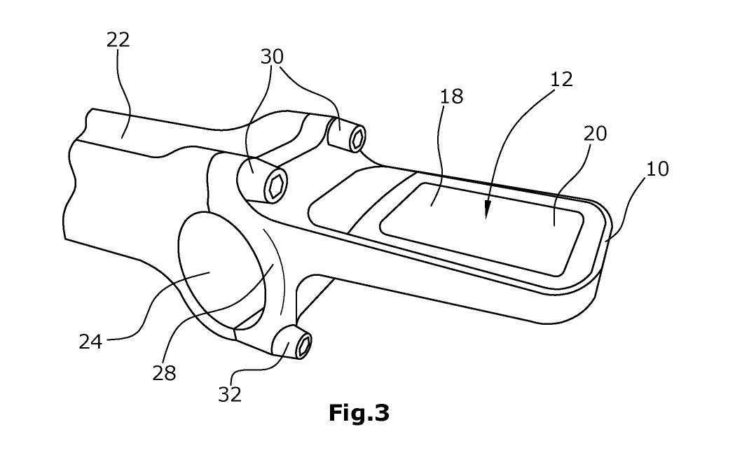

The separate and thus retrofittable bicycle computer illustrated in the Figures comprises a housing 10. A display 12 is provided at the upper side of the housing (FIG. 2). In the embodiment illustrated, a data processing means 14, as well as a combined transmitter and receiver means 16 are arranged inside the housing. The data processing means 14 is connected with the receiver means 16. The data processing means 14 is connected with the receiver means 16. The transmitter and receiver means 16 serves both for communication with sensors arranged on the bicycle or on the user and for communication with an external data processing means such as a mobile phone. In addition, further sensors, such as pressure sensors, may be arranged on the housing.

The display 12 has a closed portion 18 and an open portion 20 for displaying, in the closed portion 18, the corresponding information detected via the sensors or determined internally, while the information transmitted via the external data processing means are displayed in the open portion 20. Thus, the open portion 20 serves as an additional screen of the external data processing means.

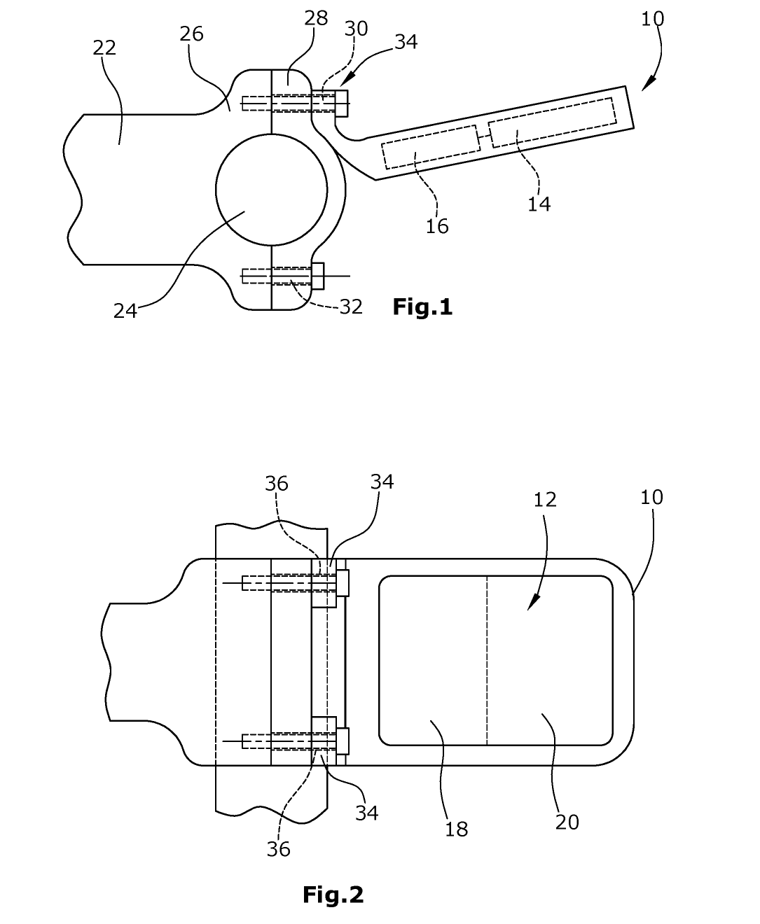

The embodiment of the bicycle computer of the present disclosure illustrated in FIGS. 1 and 2 is fastened on the handlebar stem 22. The handlebar stem 22 has an opening 24 in which the handlebar is arranged for mounting. The handlebar, not illustrated herein, is fixed in the opening 24 by means of a fixture device 26 integrally formed with the stem 22, as well as with a stem cap 28 opposite the fixture device. The fixture device 26 usually has bores with internal threads into which usually four screws, two upper screws 30 and two lower screws 32, are threaded. Thereby, the handlebar is retained in the opening 24 by clamping.

For the purpose of fixing the bicycle computer, the housing 10 is connected with a fixture device. In the embodiment illustrated, the latter is formed with two upward extending protrusions 34. Each of the two protrusions 34 has an opening or a passage bore 36. The upper screws 30 are passed through the two passage bores 36, as illustrated in FIG. 1, so that the fixation of the handlebar by clamping at the same time serves to fix the bicycle computer.

In the second preferred embodiment (FIG. 3), in which the housing of the bicycle computer is formed integrally with the stem cap, similar and identical elements are identified by the same reference numerals.

In particular, the display 12 again has a closed portion 18 and an open portion 20. The corresponding components, in particular a data processing means 14 and a transmitter and receiver means 16, may be arranged inside the housing 10.

The essential difference is that the housing 10 is formed integrally with the stem cap 28. When the handlebar is fixed in the opening 24 by means of the screws 32, the bicycle computer is automatically fixed as well.

Both embodiments illustrated in the drawings are preferably equipped with a display that has a closed portion 18 and an open portion 20. Thus, it is possible to realize the functions described above in a simple manner, in particular the communication with the external data processing means such as a mobile phone.

What is claimed is:

1. A bicycle computer comprising:
a housing,
a data processor arranged in the housing,
a receiver arranged in the housing that receives data from a sensor arranged in or on the bicycle and/or on the user,
a display for indicating information, the display being connected with the housing,
wherein the housing is formed integrally with a stem cap.

2. The bicycle computer of claim 1, wherein the housing is connected with the stem cap in a region of the cap that is an upper region in the mounted state thereof.

3. The bicycle computer of one of claim 1, wherein display is oriented substantially horizontally in the mounted state.

4. A bicycle computer comprising:
a housing,
a data processor arranged in the housing,
a receiver arranged in the housing to receive data from a sensor arranged in or on the bicycle and/or on the user,
a display for indicating information, the display being connected with the housing, and
a fixture device connected with the housing for fastening the bicycle computer to a bicycle,
wherein the fixture device is designed for mounting on a stem cap.

5. The bicycle computer of claim 4, wherein the fixture device has at least one protrusion with an opening for passing a fastener therethrough.

6. The bicycle computer of claim 5, wherein said fastener is a fastening screw for the stem cap

7. A bicycle computer comprising:
a housing,
a data processor arranged in the housing,
a receiver arranged in the housing to receive data from a sensor arranged in or on the bicycle and/or on the user,
a display for indicating information, the display being connected with the housing,
wherein the display has a closed portion for displaying permanently preset information and an open portion for displaying information transmitted from an external data processor.

8. The bicycle computer of claim 7, wherein an additional receiver is provided to receive data from the external data processor.

9. The bicycle computer of claim 7, further comprising a transmitter arranged in the housing that transmits data to the external data processor.

10. The bicycle computer of claim 7, wherein the size of the portions is variable.
